(19) United States
(12) Patent Application Publication
(10) Pub. No.: US 2008/0300990 A1
(43) Pub. Date: Dec. 4, 2008

(54) Web-Based Performance Points System

(76) Inventors: V. Richard Guiton, Marina Del Rey, CA (US); M. Gary LaFever, Lyons, CO (US)

Correspondence Address: HOLME ROBERTS & OWEN, LLP, 299 SOUTH MAIN, SUITE 1800, SALT LAKE CITY, UT, 84111, US

(21) Appl. No.: 12/131,858

(22) Filed: Jun. 2, 2008

Related U.S. Application Data
(60) Provisional application No. 60/941,572, filed on Jun. 1, 2007.

(51) Int. Cl. G06Q 30/00

(52) U.S. Cl. 705/14

(57) ABSTRACT

A method and system for marketing a product. The method includes establishing a community of online users for the development and marketing of a movie. A fund is established for distribution to the community of users. At least one activity is provided that invites participation by the community of online users. Activities are offered in connection with the development of the movie and to generate interest in the movie. Means are established for gauging participation of the users in the activities. The community of users is rewarded from the fund as a function of participation in the activities. Ownership interests in the product are established for users in the online community by including revenue generated in relation to the movie.

### CROSS REFERENCE TO RELATED APPLICATIONS

The present application claims priority to and the benefit of Provisional Application No. 60/941,572 to Guiton, entitled “Web-Based Performance Points System,” filed on Jun. 1, 2007, which is herein incorporated by reference in its entirety.

### BACKGROUND OF THE INVENTION

1. Field of the Invention

The present invention is generally directed to the field of social networking through online communities or forums. Specifically, the present invention relates to the development, promotion, and commercialization of products, including movies, through participation by an online community.

2. The Relevant Technology

Product development typically involves a small group of individuals that designs and develops the product, readies the product for the market, promotes the product, and provides the product to consumers. Promotion and marketing of the product traditionally involves advertising through various media to generate interest in the product right before it is released to the public. If successful, the promotion and marketing of the product continues throughout the life of the product.

For example, in the area of film, a movie producer is the driving force behind the production of a movie. Among other duties, the producer promotes the script, finds funding for filming, and generally gets the ball rolling and keeps the ball rolling towards the eventual screening of the movie. It is not hard to imagine that the producer develops an emotional interest and bond with the movie, and many times the movie becomes the producer's “baby.”

Marketing of the movie typically involves print and advertising that is limited to the one or two weeks before the movie is scheduled to be released. The marketing is directed to individuals that have no relation to the movie other than an interest in possibly seeing the movie. Success hinges on the interest generated in the movie during the short time period reserved for promoting the movie through print and advertising. If the movie enjoys a good opening weekend, the success of the movie is virtually secured. However, conversely if the movie has a poor showing during opening weekend, then the success of the movie is doubtful.

As such, there is a need to extend the reach of marketing of a product that is not limited to traditional print and advertising methodology.

### SUMMARY OF THE INVENTION

A method and system for marketing a product. The method includes establishing a community of online users for the development and marketing of a movie. A fund is established for distribution to the community of users. At least one activity is provided that invites participation by the community of online users. Activities are offered in connection with the development of the movie and to generate interest in the movie. Means are established for gauging participation of the users in the activities. The community of users is rewarded from the fund as a function of participation in the activities. Ownership interests in the product are established for users in the online community by including revenue generated in relation to the movie.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is a diagram of a communication network capable of supporting an online community created for the development, promotion and commercialization of a product, in accordance with one embodiment of the present invention.

FIG. 2 is a data flow diagram 200 illustrating the flow of information in a method for marketing used for developing, promoting and commercializing a product, in accordance with one embodiment of the present invention.

FIG. 3 is a diagram illustrating a flow diagram illustrating a method for marketing used for developing, promoting and commercializing a product, in accordance with one embodiment of the present invention.

### DETAILED DESCRIPTION OF THE PREFERRED EMBODIMENTS

Reference will now be made in detail to the preferred embodiments of the present invention, a method and system for the development, marketing and promotion of a product, such as a movie. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

### Notation and Nomenclature

Embodiments of the present invention can be implemented on a software program for processing data through a computer system. The computer system can be a personal computer, notebook computer, server computer, mainframe, networked computer (e.g., router), handheld computer, personal digital assistant, workstation, and the like. This program or its corresponding hardware implementation is operable for enabling the development, promotion and commercialization of a product, such as a movie. In one embodiment, the computer system includes a processor coupled to a bus and memory storage coupled to the bus. The memory storage can be volatile or non-volatile and can include removable storage media. The computer can also include a display, provision for data input and output, etc.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “establishing,” “rewarding,” “providing,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

### Communication Network

Embodiments of the present invention are described within the context of a web-based system for enabling the development, promotion, and commercialization of a product, such as a movie. More specifically, a web-based system is disclosed that is associated with an online social network platform that leverages the social and economic influences of it users. The online social network platform enables its users to participate in the development, promotion, and commercialization of a product. As such, the users have a creative and economic stake in the product, such that the users feel the product and all associated offerings belong to them, even before the product is released.

Embodiments of the present invention are well suited to the development, promotion, and commercialization of any product. In one representative example, the product involves a movie, and the production of the movie. In parts of the this Application, examples that are provided that include the development, promotion, and commercialization of a movie are intended to represent the development, promotion, and commercialization of any product.

In embodiments, the online social network platform is implemented over a communication network, such as the internet. The online social network platform provides a means for participants within a defined network to interact and communicate with each other using whatever computing resource is available to the user in order to couple to and provide access the communication network 140. Some examples of these online communities include chatting forums, blogs discussing various topics, auction sites, trading sites providing a forum for exchanging goods and services, etc. In one embodiment, the related online social network is able to bring together multiple participants that share common interests or affiliations, such as the development, promotion, and commercialization of a product.

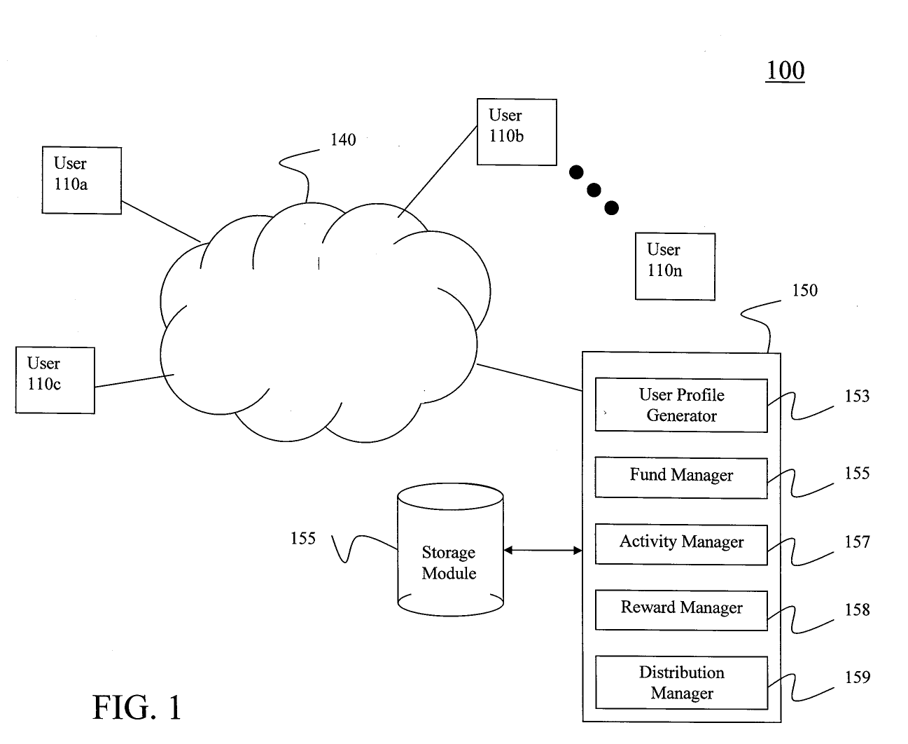

FIG. 1 is an illustration of a system 100 capable of supporting an online social network platform and corresponding social networks, in accordance with one embodiment of the present invention. System 100 includes a communication network 140 that is capable of enabling communication between one or more entities that are coupled to the network. For example, in one embodiment, the communication network 140 is the internet, but could be any suitable network capable of supporting an online social network platform and the various networks associated with the platform.

As shown in FIG. 1, server 150 is coupled to communication network 140 and is representative of the servers supporting the corresponding online community. Though shown as one block, server 150 may include one or more actual servers located in one or more locations, but act to provide server functionality to support the online social network platform. For instance, server 150 is an access point that provides access to the corresponding online community for its users. Specifically, server 150 is capable of supporting an online social network that is supports the development, promotion, and commercialization of a product.

As shown in FIG. 1, various participants or users are coupled to the communication network 140. Each of these participants is coupled to the communication network 140 through an associated computing resource (e.g., standalone computer, mobile laptop computer, mobile personal digital assistant, mobile phone, etc.) for purposes of connecting to an online community. For instance, users 110a-n are coupled to communication network 140 and are capable of participating in the online social network supported by server 150.

The online community or forum provider may require that a user of the online community to register with the online community. Registration includes the creation of a user profile by the user profile manager 153. Registration provides means for the forum provider, or a third party, to track the participation of the users in the online community for purposes of development, promotion and commercialization of the product.

In one embodiment, user profile manager 153 is capable of collecting user information that is associated with the corresponding user. In one embodiment, the user information is provided by the user, such as a user name, local address, etc., such as when the user registers with the online community. In another embodiment, the user information is automatically collected. For example, the user information includes behavioral characteristics exhibited by the user, and other personal information associated with the user.

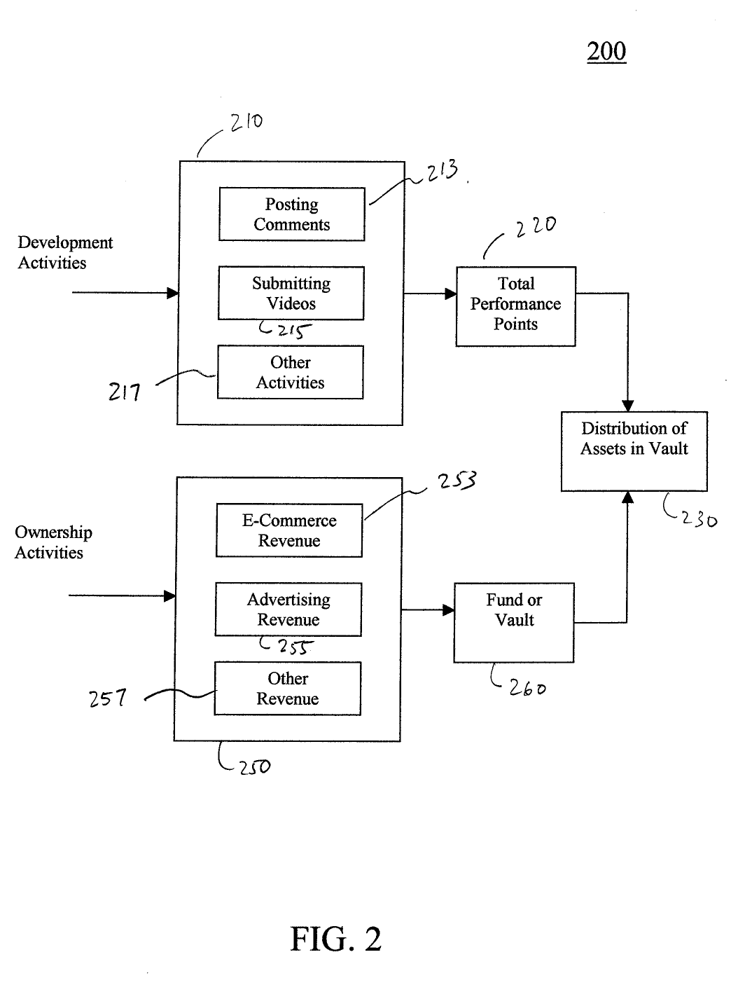

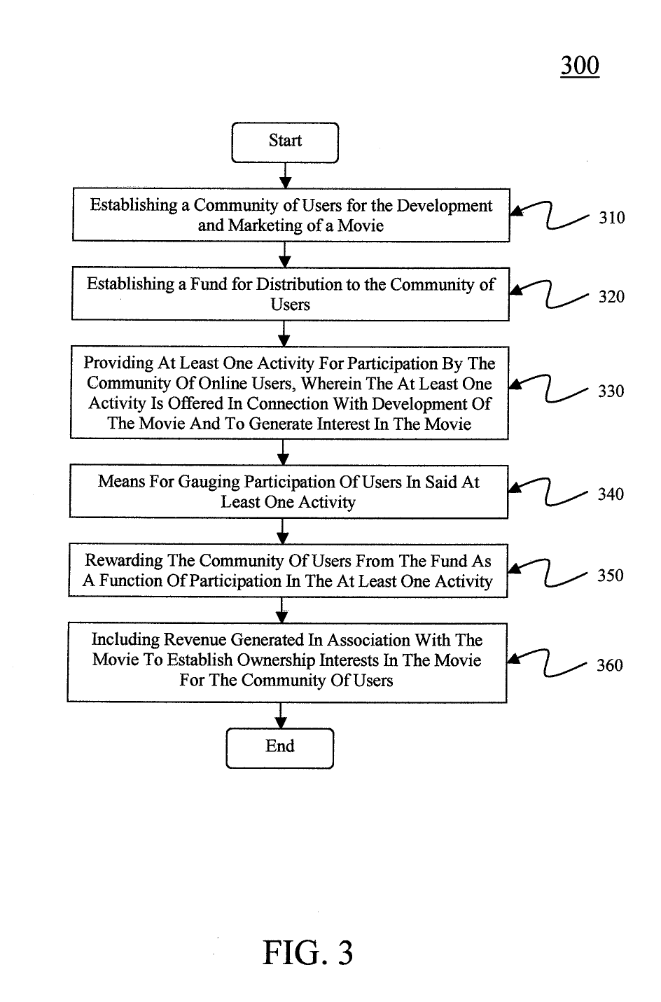

In addition, user profile manager 153 is capable of generating a user profile based on the user information. For instance, the user profile may include the user's name, address information, friend information, preferences, as well as other pertinent information. In addition, behavioral characteristics that are exhibited by the user may include uniform resource locator (URL) histories, search histories, user action on the online social network, and other user transactions that may be related to the development, promotion, and commercialization of the product. Moreover, the user profile contains information related to the participation of the corresponding user in the development, promotion, and commercialization of a product, as will be further described in relation to FIGS. 2 and 3.

These user profiles are located in the storage module 155. In addition, storage module 155 stores information related to the development, promotion, and commercialization of the product. For instance, storage module 155 stores information related to a points system created for rewarding users in their participation in activities related to the product. As shown, storage module 155 may be coupled locally to server 150. However, storage module 155 may be remotely located in other embodiments.

Server 150 that supports the online community also includes a fund manager 155 for purposes of establishing a fund for distribution to the community of users. The fund is created in order to generate interest and ownership in the product. Creation and distribution of the fund is more fully described in relation to FIGS. 2 and 3.

In addition, server 150 includes an activity manager 157 for providing one or more activities offered for participation by the community of online users, or the online community. The activities are offered in connection with the development, promotion, and commercialization of the product.

Also, server 150 includes a reward manager 158 that is capable of rewarding the community of online users associated with the online community. Rewards are assigned as a function of users participation in the offered activities. More particularly, rewards are given to a particular user based on his or her participation in the offered activities. Rewards are more fully described in relation to FIGS. 2 and 3.

Further, server 150 also includes a distribution manager 159 that enables the distribution of assets from the fund to the community of online users associated with the online community, and is more fully described in relation to FIGS. 2 and 3.

### Development, Promotion, and Commercialization of a Movie

FIG. 2 is a data flow diagram 200 illustrating the flow of information in a method for marketing used for developing, promoting and commercializing a product, in accordance with one embodiment of the present invention. The flow of information is implemented through the services provided by the online community supported by server 150 of FIG. 1, in one embodiment. For instance, a user is able to join and become active in the online community to participate in the production of a movie and to share in revenues generated from the screening of the movie.

As shown in FIG. 2, users of the online community are able to participate in the development, promotion and commercialization of a product through two avenues. The first avenue allows users to gain a creative interest in the product and is represented in block 210. The second avenue allows users to gain an ownership interest in the product and is represented in block 250.

For instance, block 210 illustrates participation in development activities by users of the online community on the host platform, associated websites, or other non-network forums. Specifically, these activities allow each user to participate at the front end of the process to develop a product. That is, these activities allow for participation in the creative development of the product. For instance, these activities include the posting of comments in discussion threads or discussion forums in block 213, submitting videos (e.g., used for developing the product) in block 215, or other activities in block 217, such as participating in online polls, referring friends to join the online community, playing online games, joining a sponsored party for the promotion of the product, etc.

Participation in any of the activities related to the product earns the corresponding user performance points. These performance points are rewards for participating in the activities. In addition, each user is associated with an accumulated value for performance points, as stored in his or her user profile. Moreover, a total number of performance points is also accumulated for all users in the online community, as reflected in block 220.

More specifically, the performance points indicate how involved is a particular user in the development process of the product. The higher the value of accumulated performance points for a user indicates a higher degree of interest in the development of the product. As the user accumulates performance points, the user becomes aware of the product and begins to develop a creative relationship with the product, even before the product is released to the public. As such, the user has a vested interest in ensuring the commercial success of the product.

Block 250 illustrates participation in ownership activities by users of the online community on the host platform, associated websites, or other non-network forums. That is, each user is able to reap the rewards of success of the product on the back end, by participating in the commercial success of the product.

For instance, users may purchase products or services related to the product, as represented in block 250. For instance, in the case of a movie, users may purchase secondary items that are related to the movie, such as video games, music, action figures, etc. that are all related to the movie. Purchase of the secondary items generates e-commerce revenues. A portion of these revenues are returned back to the forum provider supporting the online community. In addition, some of these returned revenues may also be shared by the users.

In addition, registered users are encourage to spend time on the host platform supporting the online community. The users participate in activities on the site, which generate advertising revenues, as represented in block 255. A portion of these advertising revenues may also be returned back and shared by the users in the online community.

In block 257, other revenue related to the movie is also represented. For instance, movie receipts are representative of other revenue. As such, a portion of ticket receipts can be returned back to the online community. In one example, five percent of gross ticket receipts is returned back to the online community. Other revenue includes secondary products related to the movie, such as digital versatile disc (DVD) sales, airline sales, military sales, action figures, music disks, etc.

As shown in FIG. 2, revenues generated from block 250 are contributed to a centralized account, fund, or “vault” that is represented in block 260. For purposes of the present invention, the term fund is used to represents revenues generated from participation in ownership activities by the online community. As previously described, these revenues include e-commerce revenue from the sale of secondary products and services, online advertising revenue, and other revenue. In one embodiment, the fund begins with a starting amount. For instance, in the case of a movie production, the fund may begin with five-hundred thousand dollars in US currency to stimulate interest in the development, promotion, and commercialization of the product.

As shown in block 230, each registered user of the online community can redeem the performance points he or she holds at any given time, as represented by block 230. Redemption is tied to the conversion of performance points to assets held in the fund, wherein assets include cash, etc. The conversion is determined by dividing the total value in the fund by the total performance points held by all registered users in the online community. As such, a performance point is associated with a cash value as used in the fund.

Looking at it another way, each registered user can redeem the total performance points he or she holds at any given time as a function of the percentage of the total performance points earned by all the users in the online community. That is, a user can redeem their total performance points for a percentage of the total assets in the fund, wherein the percentage is related to the percentage his or her total performance points contributes to the overall total of performance points for all users in the online community.

This percentage will constantly change as assets (e.g., cash value) is deposited into the fund from e-commerce activity, advertising, and other revenues generated in relation to the commercialization of the product. In addition, the percentage will change as the overall total of performance points increases from user activity. Also, the percentage will change as the performance points for a particular user decreases as they are redeemed. As such, each time a registered user redeems performance points, the total value (e.g., cash value) in the fund is decreased by a corresponding amount, and the total performance points for that user is also diminished by the appropriate amount.

The distribution of assets from the fund is represented by block 230. In one embodiment, the distribution is a controlled distribution. That is, only a select group of users is able to participate in the distribution of assets in the fund. In this manner, the fund remains viable, and interest is maintained in the development, promotion, and commercialization of the product, since there is no full distribution of assets in the fund. An example of controlled distribution is described in relation to FIG. 3.

FIG. 3 is a diagram illustrating a flow diagram 300 illustrating a method for marketing used for developing, promoting and commercializing a product, in accordance with one embodiment of the present invention. The method is implemented through the online community supported by server 150 of FIG. 1, in one embodiment.

Embodiments of the present invention are described within the context of developing, promoting, and commercializing any product. However, for purposes of brevity and clarity, flow diagram 300 is described in the development, promotion, and commercialization of a movie, which is representative of any product.

At 310, a community of online users is established for the development, promotion (or marketing), and commercialization of a movie. As described previously, the community of online users is supported by an online social network platform that leverages the social and economic influences of it users. As such, users of the online community develop a creative and ownership stake in the movie, as will be described below. In other words, the users become producers of the movie.

At 320, a fund is established for distribution to the community of users. The fund includes predefined assets used for the development of the movie. For instance, the fund includes a starting cash value that is used to stimulate initial interest in the development of the movie. In one case, the starting cash value is five-hundred thousand dollars. As users of the online community realize distribution of assets from the fund before the movie is released to the general public, there is an initial and immediate interest generated in the movie. This interest can be translated into the commercial success of the movie.

At 330, at least one activity is provided for participation by the community of online users. The activity is offered in connection with the development of the movie, and is intended to generate interest in the movie. More specifically, the activity is intended to generate a creative interest in the movie for all participating users. That is, the activities are configured so that participating users are able to contribute to the creative development of the movie. As such, the users gain a creative stake in the movie that develops even before the movie is released. This generation of a creative stake is a powerful tool that helps to increase the box office receipts for the opening weeks of the movie. Users who have developed a creative stake in the movie are likely to attend the movie during its opening weeks, as well as bring other friends and relations to the movie.

For instance, if an online community grows to over five million users, then each of the users are able to participate in the development of the movie. In this manner, these five million users gain a creative stake in the movie. Essentially, these users are movie producers. Having this creative stake, these users are more likely to attend a screening of the movie during its opening weeks. This translates into a higher total of ticket receipts, helping achieve box office success of the movie, as well as continued success in the secondary markets (e.g., DVD sales, compact disc (CD) sales, etc.).

In one example, a result from the activity directly impacts development of the product. That is, the result defines a controlling action in the development of the movie. For instance, the activity may be an online poll discussing plot development. As such, the result of the online poll will dictate plot development.

In another example, the activity is a discussion thread having a topic related to the development of the movie. As described previously, participation in the activity earns performance points or reward points for the user. For instance, each online entry in the discussion thread may earn the user 10 performance points. Providing the topic for the discussion thread may earn the user 1000 performance points. As such, participation in the activity generates performance points, thereby providing an incentive to continually participate in order to gain more points in relation to other users.

In addition, interest may be stimulated by providing additional points during certain periods of an activity. For instance, during a discussion thread, a time period, that is unknown to the users until the start of the time period, may be defined in which points may be increased by a factor of 2, 3, or more. As such, users have an increased interest in participating, because there may be additional points offered during the life of the activity.

In another example an online poll is used for dictating development of the movie. For instance, the online poll is used to select an actor for a role in the movie. That is, the online poll provides users with a selection of actors for a role. Results from the online poll dictates which actor will play that role in the movie.

In still another example, a contest is held to determine a winner. The winner of the contest is rewarded with additional performance points, or some other item or activity. For instance, one reward is attending a dinner with the cast of the movie.

At 340, means for gauging participation of users in the at least one activity is provided. That is, participation in the offered activities related to the development of the movie is measured. As described previously, one measurement is through the issuance of performance points. Points are issued for participating in an activity, such as online polls, discussion threads, attendance at a party, etc. In addition, points may be weighted for some activities, or periods of activities (e.g., providing additional points during a period of an activity). Furthermore, the reward points are accumulated for each user. The reward points are redeemable to obtain a distribution of assets from the fund, as described below.

At 350, the community of users is rewarded for participating in the offered activities. More specifically, the community of users is rewarded through a distribution of funds as a function of the participation in the at least one activity. As described previously, distribution of funds is made in proportion to the percentage of performance points a user has in relation to the total number of performance points for all users in the online community. In other words, a conversion ratio is developed illustrating the relationship between a value of the fund and the total value of reward points for all users. Distribution of assets is provided according to the conversion ratio and a corresponding total of reward points for each user.

In one embodiment, the distribution of assets from the fund is controlled. That is, rather than allowing for the complete withdrawal of assets from the fund, distribution is provided to a select group of users. For instance, distribution may be made once a week to the top 15 users who have the highest 15 values for accumulated performance points. In another case, the group is defined as those users having a total amount of performance points above a threshold.

In addition, the distribution is for a capped amount. For instance, the top users may share in a distribution of five-hundred dollars, or a thousand dollars, etc. That is, a subset of assets in the fund is distributed to the group of users participating in the distribution. This guarantees that a minimum amount is maintained in the fund.

In one case, after distribution, reward points are adjusted for each user. That is, the accumulated performance points for a user is diminished by the corresponding number of performance points redeemed. In addition, the total value of assets in the fund is also diminished by the amount distributed to the group of users.

In one embodiment, the distribution is achieved through a refillable debit card. Specifically, for a particular user entitled to a distribution of assets, the allocated amount is pre-paid onto the user's debit card. In this manner, a user under the age of 18 is able to participate in e-commerce without having to borrow their parents' credit or debit cards. For instance, other online payment agencies will not handle accounts for users less than 18 years of age.

At 360, revenue generated in relation to the movie is included in the fund. As such, ownership and financial interest is established for each user in the online community. For instance, a percentage of movie receipts is included in the revenue. As an example, five percent of ticket receipts is returned to the online community by including the revenue in the fund. Other examples support the inclusion of different percentages of ticket receipts for return to the online community. In addition, other revenue includes secondary markets for the movie, such as DVD sales, music sales, action figures sales, product sales related to the movie, book sales related to the movie, etc.

Accordingly, embodiments of the present invention are capable of involving an online community in the development, promotion, and commercialization of a product, such as a movie. In this manner, users in the online community gain a creative and economic stake in the product, thereby providing a guaranteed base from which to increase the revenue generated from the commercialization of the product.

While the methods of embodiments illustrated in flow chart 3 show specific sequences and quantity of operations, the present invention is suitable to alternative embodiments. For example, not all the operations provided for in the methods presented above are required for the present invention. Furthermore, additional operations can be added to the operations presented in the present embodiments. Likewise the sequences of operations can be modified depending upon the application.

A method and system for the development, promotion, and commercialization of a product, such as a movie, is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

We claim:

1. A method of marketing, comprising:
establishing a community of users for the development and marketing of a product;
establishing a fund for distribution to said community of users;
providing at least one activity for participation by said community of users to develop interest in said product from said community of users, wherein said at least one activity is connected to said product;
rewarding said community of users from said fund as a function of participation in said at least one activity;
including in said fund revenue generated in association with said product to establish ownership interests in said product for said community of users.

2. The method of claim 1, wherein said establishing a community of users further comprises:
establishing an online community of users.

3. The method of claim 1, wherein said establishing a community comprises:
establishing said community of users for the development and marketing of a movie as said product.

4. The method of claim 1, wherein said establishing a fund comprises:
guaranteeing an amount for inclusion in said fund.

5. The method of claim 1, wherein said developing interest further comprises:
providing an opportunity for said community of users to participate in the development of said product by providing a first activity, such that a result from participation in said first activity by said community of users directly impacts the development of said product.

6. The method of claim 1, wherein said developing interest in said product further comprises:
assigning reward points to users participating in said at least one activity; and
accumulating reward points earned by each user.

7. The method of claim 6, wherein said rewarding said community of users comprises:
accumulating reward points for said community of users to obtain a total value of reward points;
defining a conversion ratio between a value of said fund and said total value of reward points;
distributing assets in said fund to users according to said conversion ratio and corresponding reward points for each user.

8. The method of claim 1, wherein said developing interest comprises:
providing an online activity.

9. A method of marketing, comprising:
establishing a community of online users for the development and marketing of a movie;
establishing a fund for distribution to said community of users;
providing at least one activity for participation by said community of online users, wherein said at least one activity is offered in connection with development of said movie and to generate interest in said movie;
means for gauging participation of users in said at least one activity;
rewarding said community of users from said fund as a function of participation in said at least one activity;
establishing ownership interests in said product for said community of users by including in said fund revenue generated in relation to said movie.

10. The method of claim 9, wherein said establishing a fund comprises:
funding said fund with a starting value.

11. The method of claim 9, wherein said providing at least one activity comprises:
providing a first activity, such that a result from user participation in said first activity directly impacts development of said product.

12. The method of claim 11, wherein said providing a first activity comprises:
providing a discussion thread as said first activity having a topic related to development of said movie.

13. The method of claim 11, wherein said providing a first activity comprises:
providing an online poll used for selecting an actor for a role in said movie, wherein selection of said actor is based on said result.

14. The method of claim 9, wherein said establishing means for gauging participation comprises:
assigning reward points to each user participating in said at least one activity; and
accumulating reward points earned by each user.

15. The method of claim 14, further comprising:
increasing reward points given in a certain time period for participation in said at least one activity to generate increased interest in said movie.

16. The method of claim 14, wherein said rewarding said community of users comprises:
accumulating reward points for said community of users to obtain a total value of reward points;
defining a conversion ratio between a value of said fund and said total value of reward points;
distributing assets in said fund to users according to said conversion ratio and corresponding reward points for users.

17. The method of claim 16, wherein said distributing assets comprises:
selecting a group of users having accumulated reward points greater than a threshold;
distributing a subset of said assets in said fund to said group of users; and
adjusting accumulated reward points for said group of users based on a distribution of said subset of assets.

18. The method of claim 17, wherein said distributing a subset of said assets comprises:
distributing said subset of said assets through one or more debit cards associated with said group of users.

19. The method of claim 13, wherein said establishing ownership interests in said product for said community of users comprises:
including a percentage of movie receipts as said revenue.

20. A system for marketing, comprising:
a host platform for establishing a community of users for the development and marketing of a product;
a fund manager for establishing a fund for distribution to said community of users, wherein said fund includes a guaranteed starting value and includes revenue generated in relation to said movie;
an activity manager for providing at least one activity for participation by said community of online users, wherein said at least one activity is offered in connection with development of said product and to generate interest in said product;
a reward manager for rewarding said community of users from said fund as a function of participation in said at least one activity; and
a distribution manager for distributing assets from said fund to said community of users.

21. The system of claim 19, wherein a result from user participation in a first activity directly impacts development of said product.

22. The system of claim 19, wherein said reward manager assigns reward points to each user participating in said at least one activity, and accumulates reward points earned by each user.

23. The system of claim 22, wherein said reward manager defines a conversion ratio between a value of said fund and a total value of earned reward points by said community of online users, wherein said conversion ratio is used for distributing assets in said fund to users in said online community.

24. The system of claim 19, wherein said product comprises a movie.
